(19) United States
(12) Patent Application Publication
(10) Pub. No.: US 2025/0077647 A1
(43) Pub. Date: Mar. 6, 2025

(54) INTEGRITY CHECK VALUE TRIPWIRES FOR SPATIAL AND TEMPORAL MEMORY SAFETY

(71) Applicant: Intel Corporation, Santa Clara, CA (US)

(72) Inventors: Michael LeMay, Hillsboro, OR (US); Sebastian Osterlund, Amsterdam (NL); Floris Cornelis Gorter, Amstelveen (NL); Hans Goran Liljestrand, Helsinki (FI); Luis Kida, Beaverton, OR (US); Gabriel Ferreira Teles Gomes, Hillsboro, OR (US)

(73) Assignee: Intel Corporation, Santa Clara, CA (US)

(21) Appl. No.: 18/525,220

(22) Filed: Nov. 30, 2023

Related U.S. Application Data
(60) Provisional application No. 63/579,785, filed on Aug. 30, 2023.

(51) Int. Cl. G06F 21/54; G06F 21/55

(52) U.S. Cl. CPC G06F 21/54; G06F 21/554

(57) ABSTRACT

Techniques for using integrity check value tripwires for memory safety are described. In an embodiment, an apparatus includes an instruction decoder to decode one or more instructions to copy a memory region; and execution circuitry coupled to the instruction decoder, the execution circuitry to perform one or more operations corresponding to the one or more instructions, including detecting an integrity check value (ICV) mismatch; determining whether a granule in the memory region represents a tripwire; determining a suppression mode associated with the one or more instructions; and in response to determining that the suppression mode allows copying the tripwire, copying the tripwire.

### STATEMENT REGARDING FEDERALLY SPONSORED RESEARCH AND DEVELOPMENT

This invention was made with Government support under Agreement No. N66001-23-9-4004, awarded by Naval Information Warfare Center Pacific and funded by the Defense Advanced Research Project Agency. The Government has certain rights in the invention.

### BACKGROUND

Computers and other information processing systems may store confidential, private, and secret information in their memories. Therefore, memory safety and security are important concerns in computer system architecture and design.

### BRIEF DESCRIPTION OF DRAWINGS

Various examples in accordance with the present disclosure will be described with reference to the drawings, in which:

FIG. 1 illustrates a computing system for explicit integrity check value initialization according to an embodiment.

FIG. 2 illustrates a method for explicit integrity check value initialization according to an embodiment.

FIG. 3 illustrates a memory object including tripwires according to an embodiment.

FIG. 4 is a flow diagram illustrating integrity check value mismatch behavior during execution of a memory copy instruction according to an embodiment.

FIG. 5 is a flow diagram illustrating integrity check value mismatch behavior during execution of a memory copy instruction according to an embodiment.

FIG. 6 illustrate the depth of a pointer encoded into a cryptographic address associated with a tripwire according to an embodiment.

FIG. 7 is a flow diagram illustrating using an indication of depth of a pointer in a tripwire according to an embodiment.

FIG. 8 illustrates a nested tripwire structure according to an embodiment.

FIG. 9 illustrates a compiler output example according to an embodiment.

FIG. 10 illustrates an example of a memory object compiled without and with a tripwire attribute according to an embodiment.

FIG. 11 illustrates an example computing system.

FIG. 12 illustrates a block diagram of an example processor and/or System on a Chip (SoC) that may have one or more cores and an integrated memory controller.

FIG. 13(A) is a block diagram illustrating both an example in-order pipeline and an example register renaming, out-of-order issue/execution pipeline according to examples.

FIG. 13(B) is a block diagram illustrating both an example in-order architecture core and an example register renaming, out-of-order issue/execution architecture core to be included in a processor according to examples.

FIG. 14 illustrates examples of execution unit(s) circuitry.

FIG. 15 is a block diagram illustrating the use of a software instruction converter to convert binary instructions in a source instruction set architecture to binary instructions in a target instruction set architecture according to examples.

### DETAILED DESCRIPTION

The present disclosure relates to methods, apparatus, systems, and non-transitory computer-readable storage media for integrity check value tripwires. In an embodiment, a processor device includes an instruction decoder to decode one or more instructions to copy a memory region; and execution circuitry coupled to the instruction decoder, the execution circuitry to perform one or more operations corresponding to the one or more instructions, including detecting an integrity check value (ICV) mismatch; determining whether a granule in the memory region represents a tripwire; determining a suppression mode associated with the one or more instructions; and in response to determining that the suppression mode allows copying the tripwire, copying the tripwire.

As mentioned in the background section, memory safety and security are important concerns in computer system architecture and design.

Some approaches to protecting memory against attacks may include using an integrity check value (ICV), message authentication code (MAC), checksum, or other value (each of which may be referred to for convenience as an ICV) in an integrity checking technique to verify that a code segment, data object, code or data structure, pointer, etc. is valid and/or may be validly entered, used, etc.

Existing techniques may be limited in their ability to mitigate overflows between different fields within the same structure (e.g., intra-object overflows), overflows between multiple entries in an array, etc. Approaches according to embodiments described in this specification may overcome these limitations, for example, by adding support for establishing tripwires around fields that may be subject to overflows.

Existing techniques may also be limited in their ability to mitigate uninitialized use vulnerabilities in software, since many memory safety mechanisms consider an allocation to be fully valid as soon as it is returned by an allocator, even if it has not been initialized. Approaches according to embodiments described in this specification may also overcome these limitations, for example, by providing for setting invalid ICVs throughout an object when it is allocated and then incrementally replacing them with valid ICVs as valid data is initialized into each portion of the object.

Approaches according to embodiments described in this specification may also be used to mitigate use-after-free (UAF) vulnerabilities, to pass subroutines pointers referencing nested objects within complex hierarchies of objects with varying field types, to detect uninitialized use immediately, etc.

In embodiments, cryptographic integrity checking linked to security context contained in pointers may be performed, such that an attempt to access a memory location using an incorrect cryptographic address (CA) will (with high probability) result in an integrity check failure, which will in turn lead to an exception that may be detected. In various implementations, the integrity checking architecture may support integrity checking at various granularities (e.g., 8B, 16B, 64B). In addition to the CA, other security context (e.g., data type) may be incorporated to be bound by integrity checks.

Descriptions of embodiments, based on ICVs, cryptographic capability computing (C3), etc., are provided as examples. Embodiments may include and/or relate to other memory safety, integrity checking, etc. techniques.

For convenience and/or examples, some features (e.g., instructions, registers, etc.) may be referred to by a name associated with a specific processor architecture (e.g., Intel® 64 and/or IA32), but embodiments are not limited to those features, names, architectures, etc.

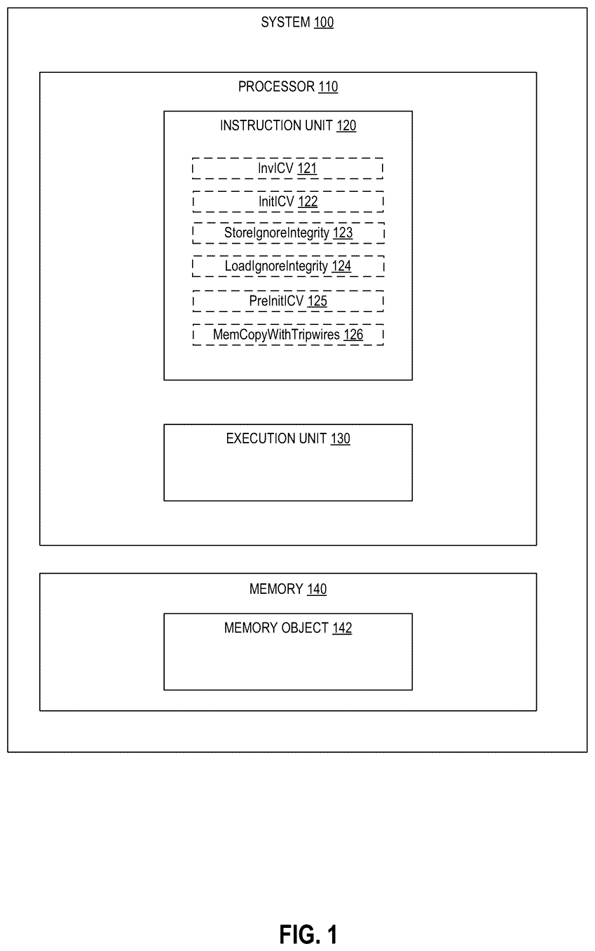

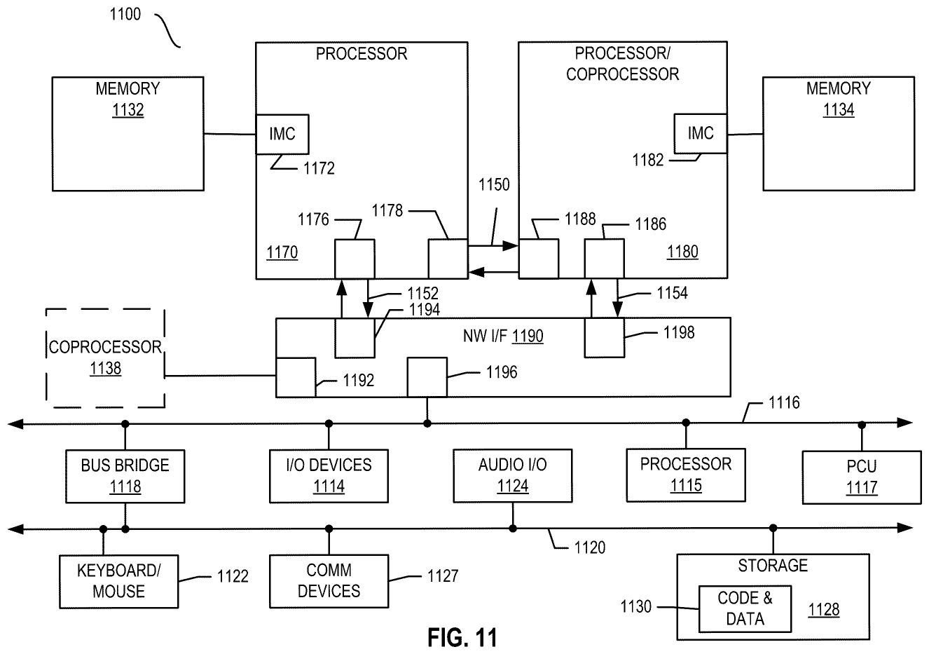

FIG. 1 illustrates an apparatus (e.g., a computing system) 100 for explicit integrity check value initialization according to an embodiment. Apparatus 100 may correspond to a computer system such as multiprocessor system 1100 in FIG. 11.

Apparatus 100 is shown in FIG. 1 as including processor 110 and memory 140, each of which may represent any number of corresponding components (e.g., multiple processors and/or processor cores, multiple dynamic random-access memories (DRAMs), etc.)

For example, processor 110 may represent all or part of one or more hardware components including one or more processors, processor cores, or execution cores integrated on a single substrate or packaged within a single package, each of which may include multiple execution threads and/or multiple execution cores, in any combination. Each processor represented as or in processor 110 may be any type of processor, including a general-purpose microprocessor, such as a processor in the Intel® Core® Processor Family or other processor family from Intel® Corporation or another company, a special purpose processor or microcontroller, or any other device or component in an information processing system in which an embodiment may be implemented. Processor 110 may be architected and designed to operate according to any instruction set architecture (ISA), with or without being controlled by microcode.

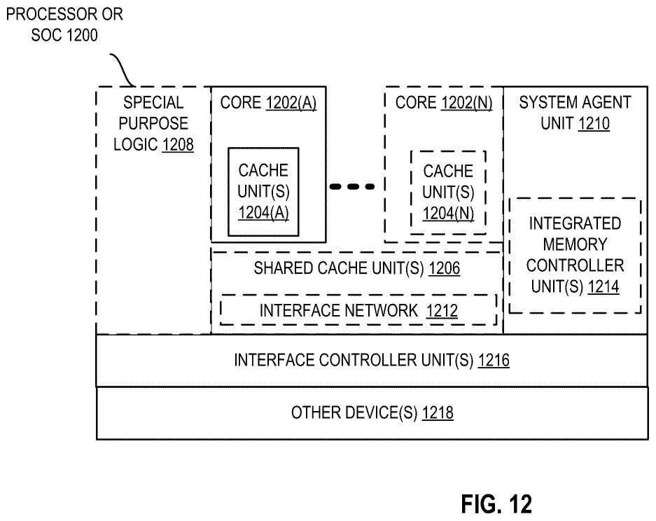

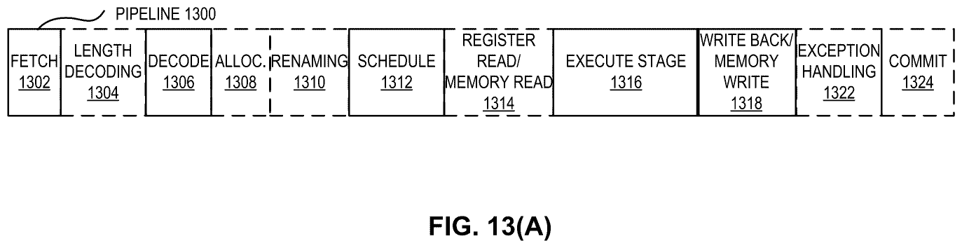

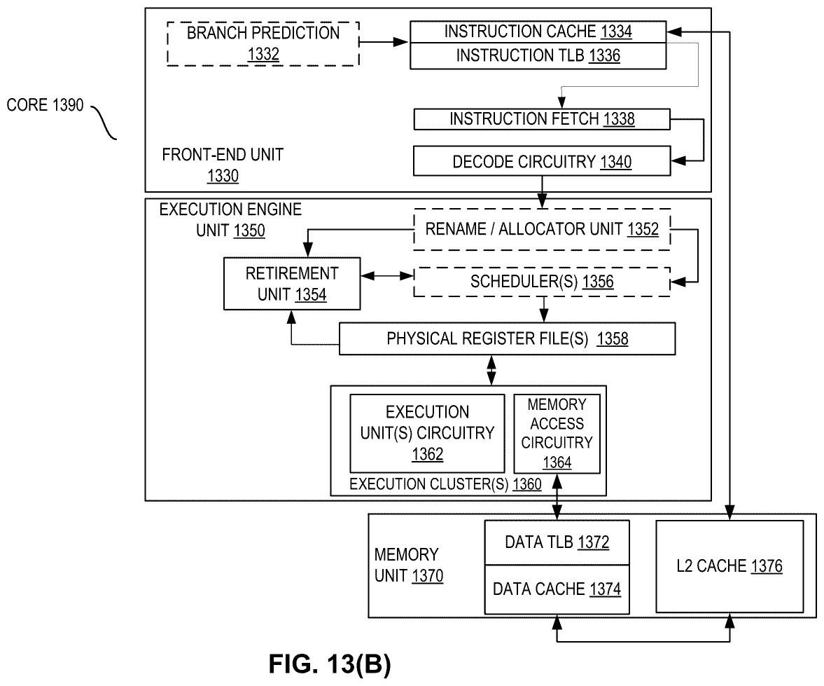

Processor 110 may be implemented in circuitry, gates, logic, structures, hardware, etc., all, or parts of which may be included in a discrete component and/or integrated into the circuitry of a processing device or any other apparatus in a computer or other information processing system. For example, processor 110 in FIG. 1 may correspond to and/or be implemented/included in any of processors 1170, 1180, or 1115 in FIG. 11, processor 1200 or one of cores 1202A to 1202N in FIG. 12, and/or core 1390 in FIG. 13(B), each as described below.

Memory 140 may represent one or more DRAMs and/or other memory components providing a system memory or other memory or storage in or for apparatus 100. Memory 140 may contain one or more memory objects 142. Any such memory object may represent an object, region, structure, segment, etc. in memory, to which the operation of explicit ICV initialization according to embodiments may be relevant.

As shown, processor 110 includes instruction unit 120 and execution unit 130. Processor 110 may include any number of each of these elements (e.g., multiple execution units) and/or any other elements not shown in FIG. 1.

Instruction unit 120 may correspond to and/or be implemented/included in front-end unit 1330 in FIG. 13(B), as described below, and/or may include any circuitry, gates, logic, structures, hardware, etc., such as an instruction decoder, to fetch, receive, decode, interpret, schedule, and/or handle instructions, such as InvICV 121, InitICV 122, StoreIgnoreIntegrity 123, LoadIgnoreIntegrity 124, PreInitICV 125, and MemCopyWithTripwires 126, each as described below, to be executed by processor 110. In FIG. 1, instructions that may be decoded or otherwise handled by instruction unit 120 are represented as blocks with broken line borders because these instructions are not themselves hardware, but rather that instruction unit 120 may include hardware or logic capable of decoding or otherwise handling these instructions.

Any instruction format may be used in embodiments; for example, an instruction may include an opcode and one or more operands, where the opcode may be decoded into one or more micro-instructions or micro-operations for execution by execution unit 130. Operands or other parameters may be associated with an instruction implicitly, directly, indirectly, or according to any other approach.

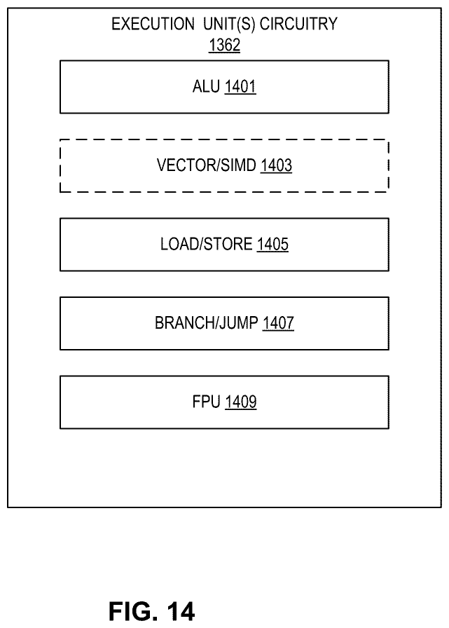

Execution unit 130 may correspond to and/or be implemented/included in any of execution engine 1350 in FIG. 13(B) and/or execution unit circuitry 1362 in FIGS. 13(B) and 14, each as described below, and/or include any circuitry, gates, logic, structures, hardware, etc., such as arithmetic units, logic units, floating point units, shifters, load/store units, etc., to process data and execute instructions (including those shown in FIG. 1), micro-instructions, and/or micro-operations. Execution unit 130 may represent any one or more physically or logically distinct execution units.

### Example Instructions

Embodiments may include the use of the following instructions, indicated by an example mnemonic followed by one or more example operand sources (e.g., memory or register) and sizes. The example mnemonics are used for convenience and any such instructions may be referred to, instead or in addition, by one of more other mnemonics and/or names (e.g., MemCopy WithTripwires may be referred to as MemCopy).

Furthermore, embodiments and/or use of embodiments may include or involve instructions (e.g., as described below) in an instruction set of a processor core or processor. The execution of an instance of each such instruction by an apparatus (e.g., a processor core, processor, system on a chip, computer, information processing system, etc.) includes performing one or more operations (e.g., as described below) specified by an opcode and/or associated information (e.g., a prefix). Code to be executed by the apparatus may include one or more instances of one or more such instructions. In this specification, the term “single instruction” (or first, second, first single, second single, etc. instruction) may be used to refer to a member of the instruction set (e.g., based on its opcode, the operations to be performed, its definition, etc.), so as to distinguish between a first case of multiple instances of the same single instruction (e.g., a first instance of MemCopy WithTripwires and a second instance of MemCopyWithTripwires) and a second case of instances of different single instructions (e.g., an instance of InitICV and an instance of MemCopy With Tripwires).

### InvICV m8

Operation: Invalidate (e.g., zero out) the ICV covering the granule of memory containing the specified memory address. Subsequent accesses to that location will (with high probability) generate an integrity check violation. Optionally, check that the integrity check succeeds for the initial ICV using the specified CA prior to invalidating the ICV. This option may be useful for avoiding potential denial of service scenarios due to an adversary invalidating memory locations that they are not authorized to access.

InitICV m64, r64 (and Analogously for Other Data Operand Sizes)

Operation: Set the specified data memory location to the specified data value, performing CA-based data encryption if applicable. Set the associated ICV. If the specified data operand size is smaller than the integrity checking granularity, then any existing data within that granule is read and used for computing the associated ICV as well. If the access is large or unaligned such that it spans multiple integrity check granules, then each of the relevant ICVs is initialized.

StoreIgnoreIntegrity m64, r64 (and Analogously for Other Data Operand Sizes)

Operation: If a series of stores is to be performed to fully initialize a single granule of data, then it may result in more precise uninitialized use checking to be able to wait to initialize the ICV until all of the initialization stores have been completed. However, by default, ordinary data stores will perform integrity checks. Thus, if ordinary stores were used to initialize the earlier values within the granule, then spurious integrity check violations would occur. Instead, the compiler may instrument software to use a series of StoreIgnoreIntegrity instructions to update the data without performing integrity checks. The final initialization store to the granule will be performed using an InitICV instruction.

LoadIgnoreIntegrity m64, r64 (and Analogously for Other Data Operand Sizes)

Operation: If a series of loads is to be performed to fully initialize a single granule of data, then it may result in more precise uninitialized use checking to be able to wait to initialize the ICV until all of the initialization loads have been completed. However, by default, ordinary data loads will perform integrity checks. Thus, if ordinary loads were used to initialize the earlier values within the granule, then spurious integrity check violations would occur. Instead, the compiler may instrument software to use a series of LoadIgnoreIntegrity instructions to update the data without performing integrity checks. The final initialization load to the granule will be performed using an InitICV instruction.

MemCopyWith Tripwires dest:m64, src:m64, Size:r64

Operation: Copy a memory region of the specified size from the source location to the destination location. For each granule of memory, if the integrity check succeeds for the source granule, then initialize the ICV at the destination location using the data loaded from the source. Otherwise, check whether the decrypted value of the granule is a “magic number” indicating that the granule is an intra-object tripwire. If so, invalidate the ICV of the destination granule. Otherwise, generate an integrity check violation exception. Some embodiments may have an upper limit on the size of the memory copy that can feasibly be performed using this instruction. For larger copies, it may be necessary to use repeated sequences of distinct instructions to copy memory in smaller units, updating architectural state as the copy proceeds so that the copy can be resumed in the event that it is interrupted or generates an exception. For example, the REP MOVS instruction permits copying data from a location indicated by the value of a particular register to a location indicated by the value of a different particular register. The repetition count is indicated in a third register. All three of these registers may be updated as the copy progresses, which would allow resuming the copy if it is interrupted or generates an exception. A new instruction encoding could be specified to indicate that the memory copy should also copy tripwires. For example, a prefix could be prepended, e.g., resulting in an encoding of DS REP MOVS. Alternative embodiments may indicate in a control register or flags register whether REP MOVS operations should copy tripwires.

PreInitICV m64, r64, Imm8 (and Analogously for Other Data Operand Sizes)

Operation: The same as InitICV, except also set a “PreInit” flag bit associated with the granule to indicate that the granule has not yet been fully initialized. Any attempt to perform an ordinary load from the granule while the PreInit flag bit is set will be treated as an integrity violation. The PreInit flag bit may be included as part of the granule value to be integrity-checked to mitigate an adversary modifying that bit directly, e.g., via a memory interposer. The immediate operand indicates whether this granule is expected to have already been initialized with a valid ICV, i.e., whether PreInitICV should perform integrity checks on the initial value of the granule prior to updating its value and ICV. An analogous change to InitICV may allow it to operate on either uninitialized or partially initialized memory locations. Some embodiments may incorporate the PreInit indicator flag as part of the tweak for generating the ICV as an alternative to storing the PreInit indicator flag as metadata.

PreInitICV may be used as an alternative to StoreIgnoreIntegrity or LoadIgnoreIntegrity, because using StoreIgnoreIntegrity or LoadIgnoreIntegrity to bypass integrity checks may allow an adversary to potentially corrupt data without being detected, e.g., after the data is emplaced with StoreIgnoreIntegrity or LoadIgnoreIntegrity and prior to InitICV being executed for the containing granule.

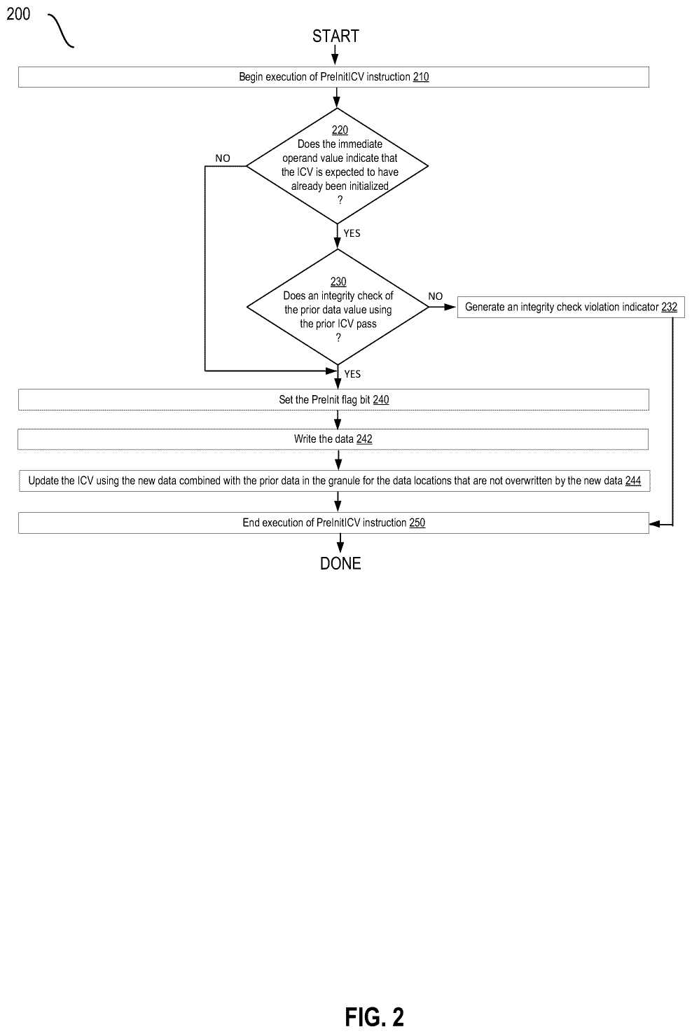

The operation of PreInitICV is illustrated in FIG. 2.

FIG. 2 illustrates a method 200 for explicit ICV initialization according to an embodiment. Method 200 may be performed by and/or in connection with the operation of an apparatus such as apparatus 100 in FIG. 1; therefore, all or any portion of the preceding description of apparatus 100 may be applicable to method 200.

In 210, a PreInitICV instruction is decoded and execution of the decoded instruction begins.

In 220, it is determined whether the immediate operand value indicates that the ICV is expected to have already been initialized. If so, then method 200 continues in 230. If not, then method 200 continues in 240.

In 230, it is determined whether an integrity check of the prior data value using the prior ICV passes. If not, then in 232, an integrity check violation indicator is generated. If so, then method 200 continues in 240.

In 240, the PreInit flag bit is set. In 242, the new data is written. In 244, the ICV is updated using the new data combined with the prior data in the granule for the data locations that are not overwritten by the new data.

In 250, execution of the PreInitICV instruction ends.

### Example Usages

In embodiments, software may use these instructions to mitigate uninitialized use, in tra-object overflow, UAF, other memory safety vulnerabilities, etc.

For example, to mitigate UAF vulnerabilities, a memory allocator may use InvICV to invalidate all or a portion of the ICVs for a freed allocation or a freed portion of an allocation, e.g., one that has been shrunk using realloc. However, UAF issues are typically relevant to security when they occur after the underlying memory has been reallocated. Thus, the allocator may choose to not incur the overhead of explicitly invalidating ICVs as long as the new CA is used to reference the underlying memory after it has been reallocated. If an adversary corrupts freed and reallocated memory using the stale CA, that will likely be detected when the pointer to the new allocation is used to load the data. Conversely, if the adversary attempts to read out, via the stale CA, fresh data written via the fresh CA, that will also likely be detected.

As another example, to mitigate uninitialized use vulnerabilities, the compiler may instrument code such that the first instructions to initialize an allocation (e.g., the first stores to an object just returned by malloc or the first stores to a fresh stack allocation) may be emitted as PreInitICV or InitICV instructions.

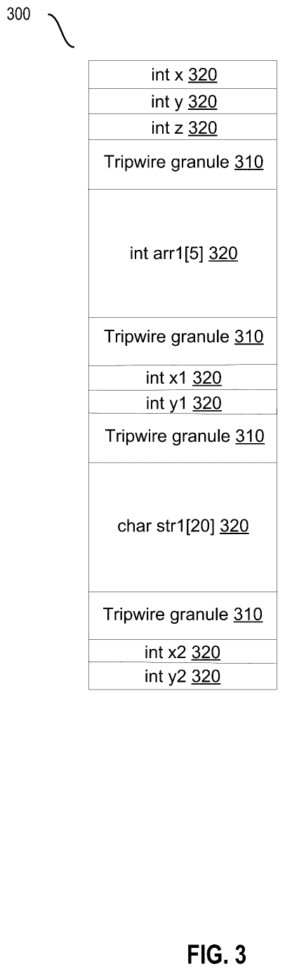

As another example, to mitigate intra-object overflows, the compiler may adjust structure layouts to leave one or more granules of padding (tripwires) around structure fields that may be susceptible to overflows, as shown in FIG. 3. The compiler may omit initializing those padding regions such that linear overflows into those regions may be detected.

FIG. 3 illustrates an example of a memory object 300 including tripwire granules 310 around structure fields 320 according to an embodiment. Memory object 300 may correspond to an instance of memory object 142 in FIG. 1.

For compatibility with bulk memory operations on objects containing embedded tripwires, MemCopy WithTripwires instruction (or other instructions for copying data including tripwires) may be used to propagate tripwires to a new location.

### Additional Tripwire Examples

Embodiments may include other new instructions, tripwire formats, and compiler logic for increasing the precision of detection (e.g., narrowing accesses to nested structures) and improving compatibility with common software idioms such as separate allocation and type assignment operations (e.g., for C structs, memory swapping, and memory copies that need the ability to overwrite reused destinations with various prior states). Integrity protections may be extended to unencrypted data regions.

In embodiments, integrity checking instructions may be used to configure the strictness of memory copying operations to balance software compatibility with security coverage, as well as for transferring data and ICVs separately while swapping memory. In embodiments, tripwire and/or cryptographic address (CA) formats may be used to indicate the depths of associated nested structures to allow restricting accesses more tightly during memory copy operations. In embodiments, compilers may be enhanced to provide greater compatibility with software idioms such as C structure use and to allow flexible control over where security hardening is applied.

Use of embodiments may address important memory safety issues, for example by more thoroughly and compatibly enforcing intra-object memory safety and mitigating uninitialized use and use-after-free.

### Extending Integrity Checking to Unencrypted Data

In embodiments, integrity checking may be applied to unencrypted data that is accessed using Linear Addresses (LAs), which may involve using the LA as a tweak when generating an Integrity Check Value (ICV). Embodiments may include a mode setting to select whether LAs are simply blocked from accessing granules with initialized ICVs or being used as a tweak to check the ICV. Note that the latter mode may have the effect of blocking accesses using an LA to granules initialized with a CA tweak with high probability. In this case, instruction definitions below that accept CA operands may be extended to also accept LA operands. Similarly, rules described below for checking tripwires and copying tripwires to and from memory that may have various CA-based ICV states can apply to equivalent LA-based ICV states.

Compatibility with Memory Swapping

Operating systems typically swap memory to and from mass storage to accommodate fluctuating memory demands. However, the swapping procedure may be unaware of the proper CA for accessing each granule of memory, which may lead to integrity check violations. Swapping compatibility may be provided by defining a mode, flag setting, instruction, or instruction-level override in which accesses via LAs ignore ICVs and allow access to the raw memory contents, e.g., ciphertext for granules that were initialized using CAs. For example, the OS may use this while swapping memory pages. For example, see the MovWithoutICV instruction definition below.

An instruction may also be defined for accessing the ICVs directly (both read and write access) to permit them to be swapped alongside their corresponding data pages. See the MovICV instruction definition below for details.

Use of such instructions as were described above should be limited to authorized portions of programs to mitigate tampering attempts, although generating the ICVs cryptographically may also provide a level of protection.

### Example Instructions

MovWithoutICV r64, m64 (and the reverse operand ordering to store data)
Operation: Load or store data without checking or updating the ICV
MovICV r64, m64 (and the reverse operand ordering to store ICVs)
Operation: Load or store the ICV associated with the memory location specified in the memory operand to/from the specified register
Enhancing memory copy compatibility

In embodiments, appropriate rules may be enforced during memory copy operations to provide different ways of balancing compatibility with security hardening.

Some exploitation attempts make use of memcpy (e.g., using memcpy to write past the end of a buffer if the length argument is attacker-controlled). Embodiments may be used to enable detection of these kinds of scenarios. As such, there are various modes in which a MemCopyWithTripwires instruction could operate. For example, there are various types of memory granules that can be either read from source (src) or written to destination (dst):
VALID: Valid memory (ICV is valid CA)
INTRA: Intra-object tripwire (ICV is a value that may deterministically or with high probability generate an integrity check violation, e.g., ˜0, and the data memory is set to an intra-object magic value)
INVALID: Invalid memory (ICV is uninitialized or the data or ICV have been corrupted)
UNPROT: LA-accessible unencrypted memory

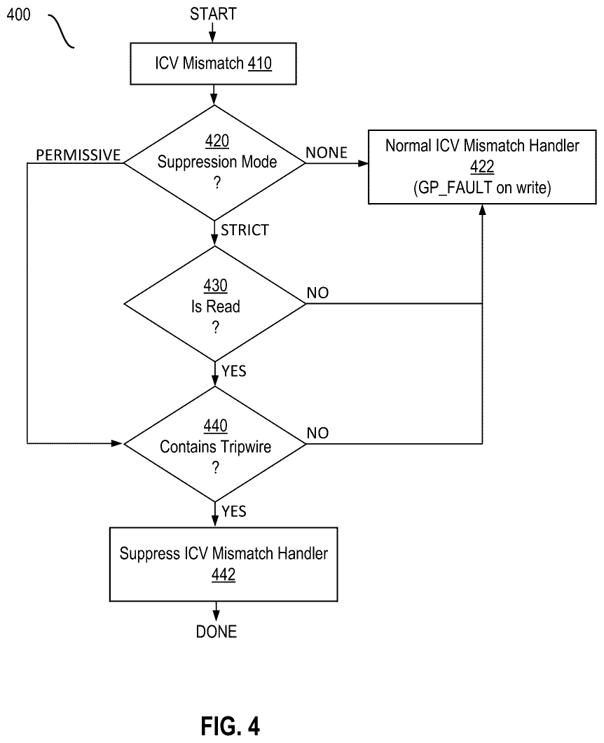

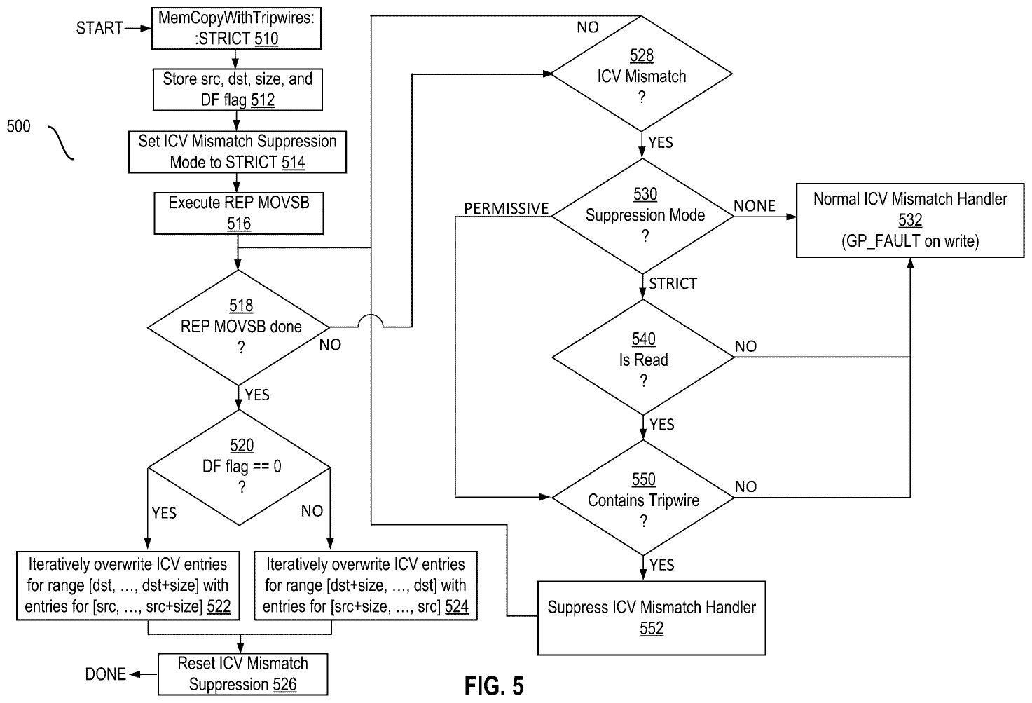

In embodiments, variants of MemCopy instructions may set different ICV mismatch suppression modes (e.g., NONE, STRICT, PERMISSIVE), which override the normal behavior of the ICV mismatch handler while the MemCopy is being performed (e.g., see FIGS. 4 and 5, each as described below).

The aim of the compiler may be to select the strictest MemCopy variant (or a conventional memory copy operation that generates an exception upon encountering any integrity check violation) that can be used at each code location without risking a false positive integrity check violation. For example, if the compiler observes that a non-aggregate value is being copied, then it can use a standard memory copy operation. On the other hand, if the compiler observes that an aggregate value is being copied to a destination aggregate value of the same type, e.g., in a C++ assignment operator, then the compiler may select a strict MemCopy. If the compiler is unable to determine the source and/or destination type for the memory copy, then it may revert to a permissive MemCopy. The compiler may use points-to analysis and/or use-def analysis to identify the source and destination types for memory copies even if the types are not apparent directly at the code location where the memory copy is performed.

FIG. 4 is a flow diagram of a method 400, illustrating ICV mismatch behavior during execution of a MemCopy instruction according to an embodiment. In 410 of method 400, an ICV mismatch is detected. In 420, the suppression mode is determined.

If, in 420, it is determined that the suppression mode is NONE, then, in 422, the normal ICV mismatch handler is invoked (e.g., resulting in a general protection fault (GP_FAULT) on a write).

If, in 420, it is determined that the suppression mode is STRICT, then, in 430, it is determined whether the operation to be performed is a read. If not, then, in 422, the normal ICV mismatch handler is invoked (e.g., resulting in a general protection fault (GP_FAULT) on a write). If so, then method 400 continues in 440, as described below.

If, in 420, it is determined that the suppression mode is PERMISSIVE, then, method 400 continues in 440.

In 440, it is determined whether the granule contains a tripwire. If not, then, in 422, the normal ICV mismatch handler is invoked (e.g., resulting in a general protection fault (GP_FAULT) on a write). If so, then, in 442, the ICV mismatch handler is suppressed, e.g., by suppressing generation of the associated exception.

FIG. 5 is a flow diagram of a method 500, illustrating ICV mismatch behavior during execution of a MemCopy instruction according to an embodiment. In 510 of method 500, execution of a MemCopy instruction with suppression mode STRICT begins.

In 512, the instructions source (src), destination (destination), size, and direction flag (DF flag) specified by the MemCopy instruction are stored. In 514, the ICV mismatch suppression mode is set to STRICT. In 516, a repeat move byte string (REP MOVSB) operation is performed to complete one of one or more of the memory copy operations specified by the MemCopy instruction. In 518, it is determined whether the REP MOVSB operations are complete. If so, then method 500 continues in 520, as described below; if not, then method 500 continues in 528, as described below.

In 528, it is determined whether there is an ICV mismatch. If so, then method 500 continues in 518. If not, then method 500 continues in 530, in which the suppression mode is determined.

If, in 530, it is determined that the suppression mode is NONE, then, in 532, the normal ICV mismatch handler is invoked (e.g., resulting in a general protection fault (GP_FAULT) on a write).

If, in 530, it is determined that the suppression mode is STRICT, then, in 540, it is determined whether the operation to be performed is a read. If not, then, in 532, the normal ICV mismatch handler is invoked (e.g., resulting in a general protection fault (GP_FAULT) on a write). If so, then method 500 continues in 550, as described below.

If, in 530, it is determined that the suppression mode is PERMISSIVE, then, method 500 continues in 550.

In 550, it is determined whether the granule contains a tripwire. If not, then, in 532, the normal ICV mismatch handler is invoked (e.g., resulting in a general protection fault (GP_FAULT) on a write). If so, then, in 552, the ICV mismatch handler is suppressed, and method 500 continues in 518.

In 520, it is determined whether the DF flag is set. If so, then in 522, the ICV entries for the range from dst to dst+size are overwritten with the entries for the range from src to src+size. If not, then in 524, the ICV entries for the range from dst+size to dst are overwritten with the entries for the range from src+size to src. In some embodiments, this may be implemented by copying the data between the ranges in the same order as the ICVs will be accessed, and either copying the ICV for the granule or invalidating the ICV for that granule if it is a tripwire granule or generating a valid ICV for the destination granule corresponding to the data copied into that granule, e.g., generating the valid destination ICV based on the destination CA in addition to the granule data.

From 522 and/or 524, method 500 continues to 526, in which ICV mismatch suppression is reset.

The aim of the compiler may be to select the strictest MemCopy variant (or a conventional memory copy operation that generates an exception upon encountering any integrity check violation) that can be used at each code location without risking a false positive integrity check violation. For example, if the compiler observes that a non-aggregate value is being copied, then it can use a standard memory copy operation. On the other hand, if the compiler observes that an aggregate value is being copied to a destination aggregate value of the same type, e.g., in a C++ assignment operator, then the compiler may select a strict MemCopy. If the compiler is unable to determine the source and/or destination type for the memory copy, then it may revert to a permissive MemCopy. The compiler may use points-to analysis and/or use-def analysis to identify the source and destination types for memory copies even if the types are not apparent directly at the code location where the memory copy is performed.

### Example Variants of MemCopyWith Tripwires

### Strict:

Description: Allow copying of SRC: “VALID|INTRA|INVALID” DST: “VALID”
Motivation: Allows copying of structs with intra-object tripwires into a newly allocated/clean destination

dst

| | CA- | CA- | CA- | LA- |
|---|---|---|---|---|
| src | VALID | INTRA | INVALID | UNPROT |
| CA-VALID | VALID | — | — | UNPROT |
| CA-INTRA | INTRA | — | — | UNPROT |
| CA-INVALID | — | — | — | — |
| LA-UNPROT | VALID | — | — | UNPROT |

Example:

my_struct_t *s = (my_struct_t *) malloc(sizeof(my_struct_t));
*s = {...} // Initialize struct elements.
void *d = malloc(sizeof(my_struct_t));
memcpy(d, s, sizeof(my_struct_t)); // Copy s's intra-object tripwires to d

Memory suppression: The strict variant sets the ICV mismatch suppression mode to STRICT (see FIG. 5, as described above)

### Permissive:

Description: Allow copying of SRC: “VALID|INTRA|INVALID” DST:
“VALID|INTRA”.Motivation: Allows copying into re-used memory allocation

dst

| | CA- | CA- | CA- | LA- |
|---|---|---|---|---|
| src | VALID | INTRA | INVALID | UNPROT |
| CA-VALID | VALID | VALID | — | UNPROT |
| CA-INTRA | INTRA | INTRA | — | UNPROT |
| CA-INVALID | — | — | — | — |
| LA-UNPROT | VALID | VALID | — | UNPROT |

Example:

my_struct_t *global_cache = (my_struct_t *)
malloc(sizeof(my_struct_t));
*global_cache = {...}; // Initialize to initial values
...
my_struct_t *s = (my_struct_t *) malloc(sizeof(my_struct_t));
*s = {...}; // Initialize struct elements.
// Copy s's data + intra-object tripwires to global_cache
memcpy(global_cache, s, sizeof(my_struct_t));
// Note that ‘global_cache’ might already have INTRA tripwires set, so
memcpy should suppress GP on these.

### PermissiveTripAware

Motivation: Similar to permissive but can prevent type-confusion attacks. In embodiments, source and destination types are compatible and the underlying tripwire and memory is known to be initialized on both source and destination at the time of copy.

dst

| | CA- | CA- | CA- | LA- |
|---|---|---|---|---|
| src | VALID | INTRA | INVALID | UNPROT |
| CA-VALID | VALID | — | — | UNPROT |
| CA-INTRA | — | INTRA | — | UNPROT |
| CA-INVALID | — | — | — | — |
| LA-UNPROT | VALID | INTRA | — | UNPROT |

### InitializeOnCopy

Description: Allow copying of SRC: “VALID|INTRA” DST: “VALID|INVALID”
Motivation: Allows optimizing allocation and data definition such that the ICV initialization during allocation may be omitted if the data is immediately defined afterward (e.g., copy constructors, where there may otherwise be an allocation+ICV-initialization immediately followed by a memcpy to define the data and thus also immediately recalculate ICVs).

dst

| | CA- | CA- | CA- | LA- |
|---|---|---|---|---|
| src | VALID | INTRA | INVALID | UNPROT |
| CA-VALID | — | — | VALID | UNPROT |
| CA-INTRA | — | — | INTRA | UNPROT |
| CA-INVALID | — | — | — | — |
| LA-UNPROT | — | — | VALID | UNPROT |

Other variations for how to respond to each possible pairing of input and output states are possible.

For large copies, in embodiments in which the instruction (e.g., MemCopyWithTripwires) does not support large copy operations, the processor may store data after reading some amount of loaded data that is smaller than the entire copy, and the instruction could be interrupted or encounter an exception at that point. In some circumstances, it would be incorrect to re-execute that entire instruction after returning from the interrupt or exception, e.g., if the earlier invocation of the instruction overwrote a portion of the source region. The processor may store state, e.g., in registers, indicating what portion of the copy has already been completed so that it may resume the copy later.

MemCopyWithTripwires could be used even for buffers that do not contain tripwires, or for which it is unknown whether they contain tripwires, e.g., those referenced using void pointers.

C++ default copy constructors and default assignment operators may also need to be enhanced to support tripwires.

To support detection of inter-object overflows during memory copies, the plaintext data value (i.e., encrypted using the object's CA prior to storing it in memory to mitigate an adversary planting the magic number elsewhere via LA accesses) for the tripwire granule may be set to a magic number that indicates it is an intra-object tripwire. There may still be some probability that the overflow will result in reading out a data value matching the magic number in the adjacent allocation, but that probability should be 2\hat{ }-(granule size). This approach would not lead to false positives, which would be a functional challenge.

In embodiments, an ICV may be a combination of a magic data value and a magic ICV value to further decrease the probability of false negatives. A tripwire may be recognized by the stored ICV being equal to the magic ICV value and data being equal to magic data value. During memory copy, if the calculated ICV mismatches the stored ICV, the memory copy compares stored ICV and data to the magic values. If the ICV value is the magic ICV value, and the data value is the magic data value, then the program may continue because it detected a tripwire. The magic ICV value may be chosen to be a different value from the ICV of the constant magic data to help avoid false negatives.

Alternatively, the magic ICV value could be used independently without a magic data value.

Other metadata could also be encoded into the ICV storage, such as permission bits, privilege level, accessed and/or dirty bits, identifier for code authorized to access the data such as a hash value, key, KeyID, tweak value or IV/counter value used by the processor circuitry to encrypt/decrypt data and/or other metadata, and element size, e.g., to allow generating an error if an attempt is made to access an allocation at an offset that is not an even multiple of the element size. Similarly, the ICV storage could also be used to label memory objects and propagate that label to other memory objects that derive data from the first one (i.e., when memory is copied), allowing for automatic propagation of permissions or other metadata. This may also be known as memory tainting or dynamic taint analysis.

### Enhancing Safety for Nested Structures

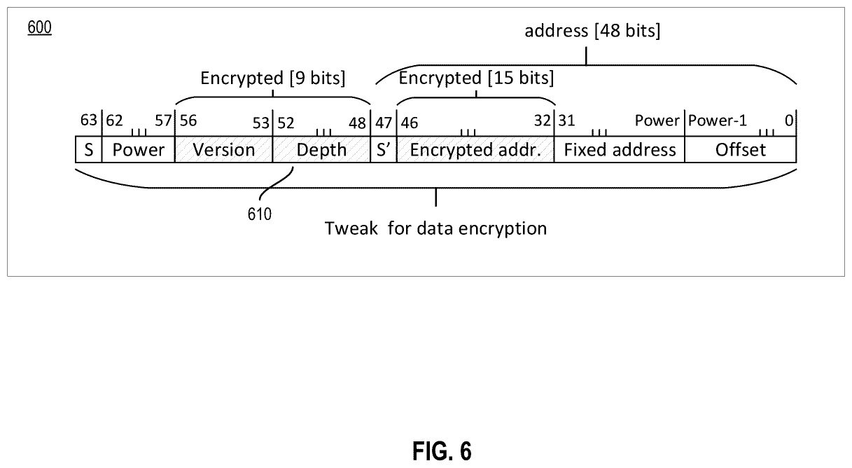

The magic number approach could be further extended to support nested structures and detect overflows beyond the bounds of a field at the appropriate level. For example, a portion of the tripwire data granule could specify the depth of the field associated with the tripwire. As depicted for example in FIG. 6, the depth (e.g., depth 610) of a pointer could be encoded into the CA (e.g., CA 600).

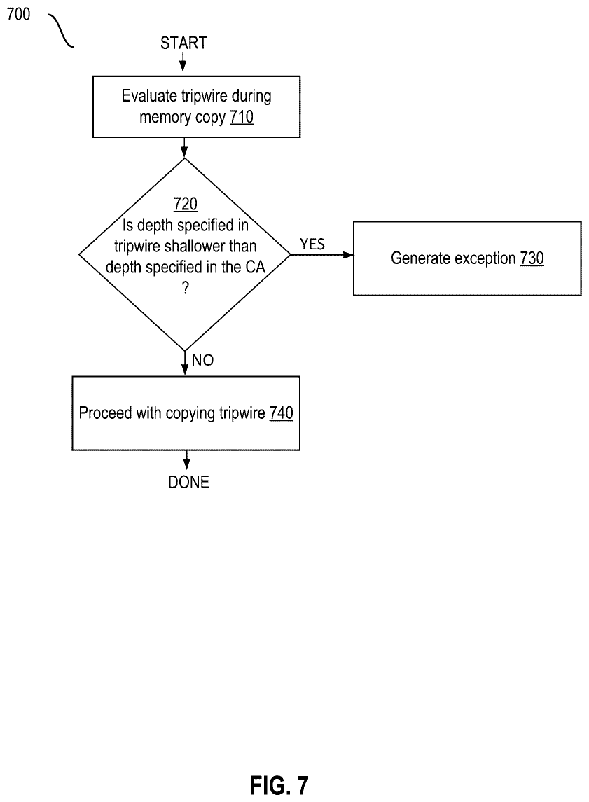

In embodiments, a memory copy operation may generate an exception if it encounters a non-tripwire integrity violation or a tripwire with a shallower depth than the one specified in the CA. For example, FIG. 7 is a flow diagram of a method 700, illustrating using an indication of depth of a pointer in a tripwire according to an embodiment.

In 710 of method 700, a tripwire is evaluated during a memory copy operation. In 710, it is determined whether the depth specified in the tripwire is shallower than the depth specified in the CA. If so, then in 730, an exception is generated without copying the tripwire. If not, then in 720, the tripwire is copied.

Encoding the depth of the pointer into the CA might consume scarce address bits or limit the supported depth that could be specified. However, this would not limit the depth of the structures. Structures deeper than the supported limit would specify the maximum supported depth, and tripwire violations during mem copies deeper than the maximum supported depth would go undetected.

Alternatively, the depth could be read from a tripwire at the starting location of the copy operation, for example, by placing a tripwire at the beginning of the top-level object in the allocation as well to have a consistent place from which to read the depth. The depth that is read out at the beginning of the copy operation may need to be stored temporarily in a register, e.g., a new control register that could be saved and restored using XSAVE/XRSTOR. Therefore, if a large copy operation is interrupted and resumed later, it would still know what depth was read out at the beginning of the copy operation. Alternatively, the approach described previously of encoding the depth into the CA would avoid saving the depth in a register. Encoding the depth into the CA would lock the copy operation to a specified level, which could mitigate some potential vulnerabilities that could update a CA to point to a field at an unauthorized level prior to beginning a copy operation.

Consider the following example to observe how this nested tripwire approach could be structured:

```
struct A {
  char a_str1[16], a_str2[16];
};
struct B {
  A a1, a2;
  char b_str[16];
};
struct C {
  B b2;
  char c_str[16];
};
```

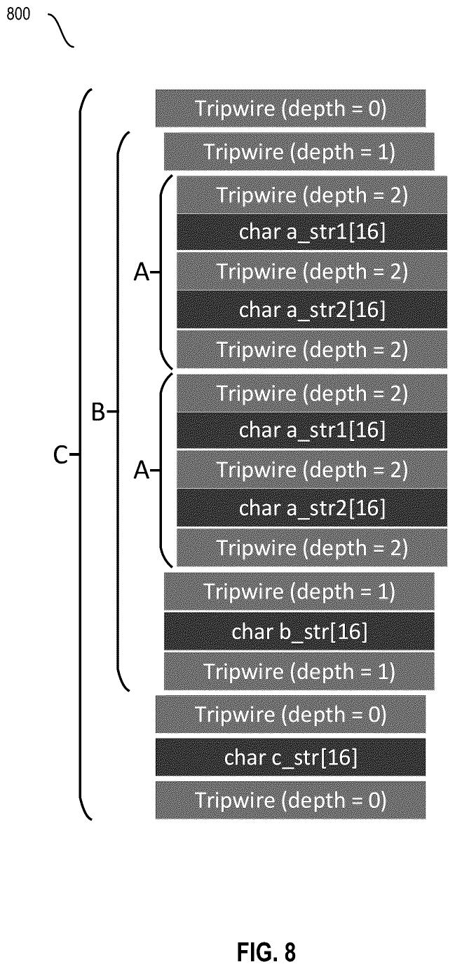

This would result in a structure such as structure 800 shown in FIG. 8.

With respect to both flat and nested tripwire designs, tripwires may also be placed between array elements as though they are distinct fields in a structure. Tripwires may even be placed between elements of arrays that are themselves contained within structures, or that are part of a multi-dimensional array. The compiler could recognize when tripwires are present between array elements and perform pointer arithmetic accordingly when indexing into such an array, i.e., multiplying the index by the size of the element and the tripwire together. Iteration through an array would be modified similarly. The compiler could also select the appropriate MemCopy variant for copying an entire array type depending on whether the source and/or destination array types contain tripwires.

Potential alternative ISA designs include:
Setting a flag, e.g., in RFLAGS, to indicate that data accesses should be allowed to read over tripwires. However, to be usable in a copy operation, embodiments may include a way to record the state of whether a tripwire was present at a location being read, which could then be used to selectively invalidate the ICV of the destination location.
In embodiments, a different instruction, e.g., “LoadAndCheckForTripwire”, may be used to load the value of the data granule into a register as well as set a flag, e.g., one of the arithmetic flags in RFLAGS, to indicate whether the ICV is valid for the location that was read. An ordinary jump instruction could then be used to control whether the ICV is invalidated in the destination location.

In embodiments that do not directly support nested tripwires with depths specified in tripwire granules adjacent to fields (e.g., using a series of copy instructions, some not copying data adjacent to the start of the field), additional state could be maintained and passed to the data/tripwire copy instructions.

In embodiments, code could zero structures, e.g., using memset, prior to initializing fields. This could be supported in at least two possible ways:
Zeroing the memory ahead of installing tripwires using ordinary memory access instructions accessing the CA. However, if multiple memsets are applied to the same allocation at different points of the program's runtime, this could result in false positive tripwire violations.
Using a new instruction that ignores intra-object tripwires. For example, a DS-prefixed variant of the REP STOS instruction could be defined to set the specified value into specified memory locations that do not contain intra-object tripwires. This would permit tripwires to be installed either before or after performing the memset, which may provide more flexible support for a wider variety of initialization idioms, including repeated zeroing operations.

### Optimizing Tripwire Placement to Minimize Memory Usage

Changes to the compiler may reduce the number of tripwires inserted. If not all fields in the structure are protected with tripwires, e.g., if tripwires are added to protect only arrays in the structure, the order of the protected and unprotected fields may reduce the total number of tripwires needed.

For example, consider the configuration if all protected objects and unprotected objects are grouped separately. The number of tripwires would then be the number of protected objects plus one.

Furthermore, the tripwire between the first or last protected element and the boundary of the struct may be removed if we consider there are already protections for overflow or underflow outside the struct. If all fields within the structure are protected by tripwires, then both the first and last tripwires may be elided in this way.

The following example uses fewer tripwires to fence the protected objects in the struct by having a single tripwire between protected objects. The second struct removes the tripwire between a fenced object and outside the struct.

struct group_fences {
// Tripwire0
char fenced_object0[64];
// Tripwire 1
char fenced_object1[64];
// Tripwire2
char fenced_object2[64]; // (n)
// Tripwire3 (n+1)
int unfenced_object0;
int unfenced_object1;
int unfenced_object2;
int unfenced_object3;
int unfenced_object4; //(k)
};
Struct nofence_to_out_of_struct {
// no tripwire to outside struct
char fenced_object0[16];
// Tripwire1
char fenced_object1;
// Tripwire2
char fenced_object2; // (n)
// Tripwire3 (n+1)
int unfenced_object0;
int unfenced_object1;
int unfenced_object2;
int unfenced_object3;
int unfenced_object4; //(k)
};

This optimization may also be applied at each level of a structure for nested structures, although some embodiments may benefit from retaining a tripwire at the beginning of each structure to indicate its level.

### Alternative Compiler Designs

In embodiments, supporting tripwires for C struct types may include an approach for detecting when the tripwires need to be installed, since C structs do not define explicit constructors. A common idiom is to cast the untyped result of a malloc to a particular type and then initialize fields within it. Such casts may be detected by compiler instrumentation and selected as the points at which tripwire initialization should be performed according to the destination type of the cast.

In embodiments, the appropriate places (in code) to invalidate the C struct tripwires (i.e., when to make the tripwires inaccessible through ICV invalidations) may be identified. Embodiments may include, for C++ class members, piggybacking on the existing constructor paradigm, and for C structs (on the heap), Intermediate Representation (IR) or Abstract Syntax Tree (AST), each as described below.

### Intermediate Representation (IR) Example

With limited type information at the LLVM IR level, it may be difficult to identify which heap memory allocations belong to structs. However, the def-use chain of the memory allocation instruction may be followed to a subsequent GEP (GetElementPtr, used to get the address of a subelement of an aggregate data structure) instruction, which specifies the type used as the basis for the calculation as the first argument. Therefore, if a GEP is present, it may be inferred whether a struct type is used to access the memory allocation. If a GEP is not present (in the same Function), or the GEP is indirectly related to a memory allocation, the def-use search may be propagated across load/store operations (e.g., a heap memory allocation of which the pointer gets stored on the stack (common on-00)). In this case, the GEP instruction is in the def-use of the stack allocation instruction.

Example GEP at IR level:
% 1=getelementptr inbounds % struct._structName, ptr % 1, i32 0, i32 5

### Abstract Syntax Tree (AST) Example

An alternative may make use of Clang's AST, with modifications. At the AST level, C struct heap allocations may be identified. Consider the following example code snippet:

```
struct target {
  int n;
  char buf[16];
  void* p;
};
struct target *alloc = (struct target*) malloc(sizeof(struct target));
```

This code may be compiled using:
$ clang++ast.cpp-O2-Xclang-ast-dump-fsyntax-only-Wno-visibility

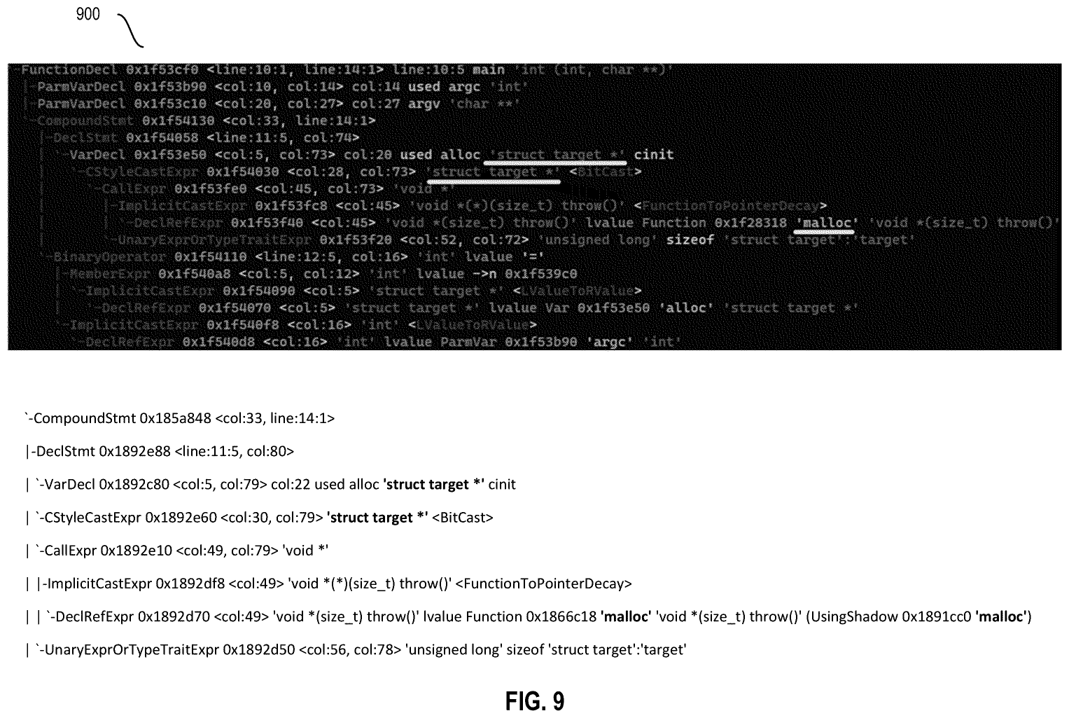

The malloc-of-a-struct pattern in the AST may be observed (see yellow highlights compiler output example 900 in FIG. 9). In this case, a call to malloc being cast to a struct type may be identified. Note that programs may store the memory allocation in a void* and later cast it (in another function). In such a case, the direct correlation between malloc and the struct pointer cast may be lost.

### Attributes

In embodiments, the compiler may support a parameter to control tripwire insertion. For example, a switch could be added named -finsert-intraobject-tripwires, e.g., optionally accepting one of the following arguments: none, all, attr. None turns off tripwire insertion and behaves as if the switch had not been passed at all to the compiler. All behaves as described in the preceding paragraphs. Attr tells the compiler to restrict insertion of tripwires only to struct members that are annotated with the tripwires attribute. This allows a fine-grained selection of tripwire insertion.

Consider the following struct type:

```
struct st {
    long l1;
    char a[8]
    attribute _attribute_((tripwires));
    long l2;
    char b[8];
    long l3;
  }
```

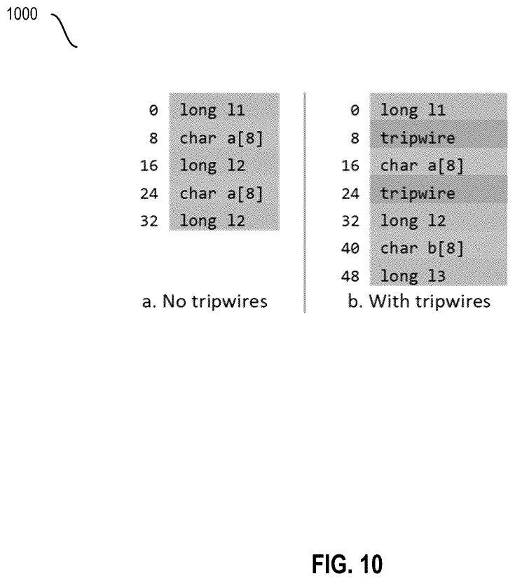

Notice how only the first of the array typed members (a) is annotated with the tripwires attribute. When an object of such type is compiled with -finsert-intraobject-tripwires=attr only this first member gets tripwires around it, as depicted in FIG. 10, which illustrates a memory object 1000 compiled without and with a tripwire attribute according to an embodiment.

### Hardening Stack and Global Regions Using Tripwires

Beyond heap allocations, tripwires may also be added in a straightforward fashion to stack and global variables that are separately encrypted.

Alternatively, embodiments may include cryptographically isolating different stack frames from each other and/or cryptographically isolating per-module regions containing global variables from each other. In these embodiments, each stack frame or per-module global variable region may be treated as an allocation with tripwires inserted within it between storage for program-level variables. Nested tripwires may be used when those program-level variables are themselves aggregate structures.

### Example Apparatuses, Methods, Etc

According to some examples, an apparatus (e.g., a processor device) includes an instruction decoder to decode a single instruction to set an integrity check value (ICV) corresponding to a destination location in a memory; and execution circuitry coupled to the instruction decoder, the execution circuitry to perform one or more operations corresponding to the single instruction, including storing data indicated by the single instruction into the destination location, and storing the ICV in the memory.

According to some examples, an apparatus (e.g., a processor device) includes an instruction decoder to decode one or more instructions to copy a memory region with tripwires; and execution circuitry coupled to the instruction decoder, the execution circuitry to perform one or more operations corresponding to the one or more instructions, including determining whether a granule in the memory region represents a tripwire.

According to some examples, an apparatus (e.g., a processor device) includes an instruction decoder to decode one or more instructions to copy a memory region; and execution circuitry coupled to the instruction decoder, the execution circuitry to perform one or more operations corresponding to the one or more instructions, including detecting an integrity check value (ICV) mismatch; determining whether a granule in the memory region represents a tripwire; determining a suppression mode associated with the one or more instructions; and in response to determining that the suppression mode allows copying the tripwire, copying the tripwire.

According to some examples, a method includes decoding, with an instruction decoder of a processor device, a single instruction to set an integrity check value (ICV) corresponding to a destination location in a memory; and performing, by the processor device, one or more operations corresponding to the single instruction, including storing data indicated by the single instruction into the destination location, and storing the ICV in the memory.

According to some examples, a method includes decoding, with an instruction decoder of a processor device, one or more instructions to copy a memory region with tripwires; and performing, by the processor device, one or more operations corresponding to the one or more instructions, including determining whether a granule in the memory region represents a tripwire.

According to some examples, a method includes decoding, with an instruction decoder of a processor device, one or more instructions to copy a memory region; and performing, by the processor device, one or more operations corresponding to the one or more instructions, including detecting an integrity check value (ICV) mismatch; determining whether a granule in the memory region represents a tripwire; determining a suppression mode associated with the one or more instructions; and in response to determining that the suppression mode allows copying the tripwire, copying the tripwire.

Any such examples may include any or any combination of the following aspects. The one or more operations may also include performing an integrity check before storing the ICV. The ICV may be invalid. The one or more operations may also include generating the ICV based at least in part on the indicated data. Generating the ICV at least in part on the indicated data may include generating the ICV at least in part on existing data already stored in a memory region including the destination location. The one or more operations may also include determining whether a memory region including the destination location is initialized. The one or more operations also includes setting a flag bit to indicate that the memory region including the destination location is not initialized. The one or more operations may also include copying the indicated data from a source location in the memory, and performing an integrity check on the indicated data.

Any such examples may include any or any combination of the following aspects. The operations also include, in response to determining that the suppression mode disallows copying the tripwire, invoking an ICV mismatch handler. The operations also include, in response to determining that the suppression mode allows copying the tripwire, suppressing the ICV mismatch handler. The tripwire is between two different fields of a data structure. The operations also include comparing a first field depth value and a second field depth value, the first field depth value indicated in the tripwire, the second field depth value indicated in an address associated with the tripwire; and in response to detecting a mismatch between the first field depth value and the second field depth value indicating that the tripwire is at a field boundary that the copy operation instruction(s) is/are not authorized to cross, generating an exception without copying the tripwire. The tripwire is between two different levels of a nested data structure. The granule consists of data and an associated ICV based on a tweak involving a linear address. The one or more instructions may be limited to a single instruction.

According to some examples, an apparatus may include means for performing any function disclosed herein; an apparatus may include a data storage device that stores code that when executed by a hardware processor or controller causes the hardware processor or controller to perform any method or portion of a method disclosed herein; an apparatus, method, system etc. may be as described in the detailed description; a non-transitory machine-readable medium may store instructions that when executed by a machine causes the machine to perform any method or portion of a method disclosed herein. Embodiments may include any details, features, etc. or combinations of details, features, etc. described in this specification.

### Example Computer Architectures

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 11 illustrates an example computing system. Multiprocessor system 1100 is an interfaced system and includes a plurality of processors or cores including a first processor 1170 and a second processor 1180 coupled via an interface 1150 such as a point-to-point (P-P) interconnect, a fabric, and/or bus. In some examples, the first processor 1170 and the second processor 1180 are homogeneous. In some examples, first processor 1170 and the second processor 1180 are heterogenous. Though the example system 1100 is shown to have two processors, the system may have three or more processors, or may be a single processor system. In some examples, the computing system is a system on a chip (SoC).

Processors 1170 and 1180 are shown including integrated memory controller (IMC) circuitry 1172 and 1182, respectively. Processor 1170 also includes interface circuits 1176 and 1178; similarly, second processor 1180 includes interface circuits 1186 and 1188. Processors 1170, 1180 may exchange information via the interface 1150 using interface circuits 1178, 1188. IMCs 1172 and 1182 couple the processors 1170, 1180 to respective memories, namely a memory 1132 and a memory 1134, which may be portions of main memory locally attached to the respective processors.

Processors 1170, 1180 may each exchange information with a network interface (NW I/F) 1190 via individual interfaces 1152, 1154 using interface circuits 1176, 1194, 1186, 1198. The network interface 1190 (e.g., one or more of an interconnect, bus, and/or fabric, and in some examples is a chipset) may optionally exchange information with a coprocessor 1138 via an interface circuit 1192. In some examples, the coprocessor 1138 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1170, 1180 or outside of both processors, yet connected with the processors via an interface such as P-P interconnect, such that either or both processors' local cache information may be stored in the shared cache if a processor is placed into a low power mode.

Network interface 1190 may be coupled to a first interface 1116 via interface circuit 1196. In some examples, first interface 1116 may be an interface such as a Peripheral Component Interconnect (PCI) interconnect, a PCI Express interconnect or another I/O interconnect. In some examples, first interface 1116 is coupled to a power control unit (PCU) 1117, which may include circuitry, software, and/or firmware to perform power management operations with regard to the processors 1170, 1180 and/or co-processor 1138. PCU 1117 provides control information to a voltage regulator (not shown) to cause the voltage regulator to generate the appropriate regulated voltage. PCU 1117 also provides control information to control the operating voltage generated. In various examples, PCU 1117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1117 is illustrated as being present as logic separate from the processor 1170 and/or processor 1180. In other cases, PCU 1117 may execute on a given one or more of cores (not shown) of processor 1170 or 1180. In some cases, PCU 1117 may be implemented as a microcontroller (dedicated or general-purpose) or other control logic configured to execute its own dedicated power management code, sometimes referred to as P-code. In yet other examples, power management operations to be performed by PCU 1117 may be implemented externally to a processor, such as by way of a separate power management integrated circuit (PMIC) or another component external to the processor. In yet other examples, power management operations to be performed by PCU 1117 may be implemented within BIOS or other system software.

Various I/O devices 1114 may be coupled to first interface 1116, along with a bus bridge 1118 which couples first interface 1116 to a second interface 1120. In some examples, one or more additional processor(s) 1115, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1116. In some examples, second interface 1120 may be a low pin count (LPC) interface. Various devices may be coupled to second interface 1120 including, for example, a keyboard and/or mouse 1122, communication devices 1127 and storage circuitry 1128. Storage circuitry 1128 may be one or more non-transitory machine-readable storage media as described below, such as a disk drive or other mass storage device which may include instructions/code and data 1130. Further, an audio I/O 1124 may be coupled to second interface 1120. Note that other architectures than the point-to-point architecture described above are possible. For example, instead of the point-to-point architecture, a system such as multiprocessor system 1100 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

FIG. 12 illustrates a block diagram of an example processor and/or SoC 1200 that may have one or more cores and an integrated memory controller. The solid lined boxes illustrate a processor 1200 with a single core 1202(A), system agent unit circuitry 1210, and a set of one or more interface controller unit(s) circuitry 1216, while the optional addition of the dashed lined boxes illustrates an alternative processor 1200 with multiple cores 1202(A)-(N), a set of one or more integrated memory controller unit(s) circuitry 1214 in the system agent unit circuitry 1210, and special purpose logic 1208, as well as a set of one or more interface controller units circuitry 1216. Note that the processor 1200 may be one of the processors 1170 or 1180, or co-processor 1138 or 1115 of FIG. 11.

Thus, different implementations of the processor 1200 may include: 1) a CPU with the special purpose logic 1208 being integrated graphics and/or scientific (throughput) logic (which may include one or more cores, not shown), and the cores 1202(A)-(N) being one or more general purpose cores (e.g., general purpose in-order cores, general purpose out-of-order cores, or a combination of the two); 2) a coprocessor with the cores 1202(A)-(N) being a large number of special purpose cores intended primarily for graphics and/or scientific (throughput); and 3) a coprocessor with the cores 1202(A)-(N) being a large number of general purpose in-order cores. Thus, the processor 1200 may be a general-purpose processor, coprocessor, or special-purpose processor, such as, for example, a network or communication processor, compression engine, graphics processor, GPGPU (general purpose graphics processing unit), a high throughput many integrated cores (MIC) coprocessor (including 30 or more cores), embedded processor, or the like. The processor may be implemented on one or more chips. The processor 1200 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1204(A)-(N) within the cores 1202(A)-(N), a set of one or more shared cache unit(s) circuitry 1206, and external memory (not shown) coupled to the set of integrated memory controller unit(s) circuitry 1214. The set of one or more shared cache unit(s) circuitry 1206 may include one or more mid-level caches, such as level 2 (L2), level 3 (L3), level 4 (L4), or other levels of cache, such as a last level cache (LLC), and/or combinations thereof. While in some examples interface network circuitry 1212 (e.g., a ring interconnect) interfaces the special purpose logic 1208 (e.g., integrated graphics logic), the set of shared cache unit(s) circuitry 1206, and the system agent unit circuitry 1210, alternative examples use any number of well-known techniques for interfacing such units. In some examples, coherency is maintained between one or more of the shared cache unit(s) circuitry 1206 and cores 1202(A)-(N). In some examples, interface controller unit circuitry 1216 couples the cores 1202 to one or more other devices 1218 such as one or more I/O devices, storage, one or more communication devices (e.g., wireless networking, wired networking, etc.), etc.

In some examples, one or more of the cores 1202(A)-(N) are capable of multi-threading. The system agent unit circuitry 1210 includes those components coordinating and operating cores 1202(A)-(N). The system agent unit circuitry 1210 may include, for example, power control unit (PCU) circuitry and/or display unit circuitry (not shown). The PCU may be or may include logic and components needed for regulating the power state of the cores 1202(A)-(N) and/or the special purpose logic 1208 (e.g., integrated graphics logic). The display unit circuitry is for driving one or more externally connected displays.

The cores 1202(A)-(N) may be homogenous in terms of instruction set architecture (ISA). Alternatively, the cores 1202(A)-(N) may be heterogeneous in terms of ISA; that is, a subset of the cores 1202(A)-(N) may be capable of executing an ISA, while other cores may be capable of executing only a subset of that ISA or another ISA.

### Example Core Architectures—In-Order and Out-of-Order Core Block Diagram

FIG. 13(A) is a block diagram illustrating both an example in-order pipeline and an example register renaming, out-of-order issue/execution pipeline according to examples. FIG. 13(B) is a block diagram illustrating both an example in-order architecture core and an example register renaming, out-of-order issue/execution architecture core to be included in a processor according to examples. The solid lined boxes in FIGS. 13(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 13(A), a processor pipeline 1300 includes a fetch stage 1302, an optional length decoding stage 1304, a decode stage 1306, an optional allocation (Alloc) stage 1308, an optional renaming stage 1310, a schedule (also known as a dispatch or issue) stage 1312, an optional register read/memory read stage 1314, an execute stage 1316, a write back/memory write stage 1318, an optional exception handling stage 1322, and an optional commit stage 1324. One or more operations can be performed in each of these processor pipeline stages. For example, during the fetch stage 1302, one or more instructions are fetched from instruction memory, and during the decode stage 1306, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1306 and the register read/memory read stage 1314 may be combined into one pipeline stage. In one example, during the execute stage 1316, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 13(B) may implement the pipeline 1300 as follows: 1) the instruction fetch circuitry 1338 performs the fetch and length decoding stages 1302 and 1304; 2) the decode circuitry 1340 performs the decode stage 1306; 3) the rename/allocator unit circuitry 1352 performs the allocation stage 1308 and renaming stage 1310; 4) the scheduler(s) circuitry 1356 performs the schedule stage 1312; 5) the physical register file(s) circuitry 1358 and the memory unit circuitry 1370 perform the register read/memory read stage 1314; the execution cluster(s) 1360 perform the execute stage 1316; 6) the memory unit circuitry 1370 and the physical register file(s) circuitry 1358 perform the write back/memory write stage 1318; 7) various circuitry may be involved in the exception handling stage 1322; and 8) the retirement unit circuitry 1354 and the physical register file(s) circuitry 1358 perform the commit stage 1324.

FIG. 13(B) shows a processor core 1390 including front-end unit circuitry 1330 coupled to execution engine unit circuitry 1350, and both are coupled to memory unit circuitry 1370. The core 1390 may be a reduced instruction set architecture computing (RISC) core, a complex instruction set architecture computing (CISC) core, a very long instruction word (VLIW) core, or a hybrid or alternative core type. As yet another option, the core 1390 may be a special-purpose core, such as, for example, a network or communication core, compression engine, coprocessor core, general purpose computing graphics processing unit (GPGPU) core, graphics core, or the like.

The front-end unit circuitry 1330 may include branch prediction circuitry 1332 coupled to instruction cache circuitry 1334, which is coupled to an instruction translation lookaside buffer (TLB) 1336, which is coupled to instruction fetch circuitry 1338, which is coupled to decode circuitry 1340. In one example, the instruction cache circuitry 1334 is included in the memory unit circuitry 1370 rather than the front-end circuitry 1330. The decode circuitry 1340 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1340 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1340 may be implemented using various different mechanisms. Examples of suitable mechanisms include, but are not limited to, look-up tables, hardware implementations, programmable logic arrays (PLAs), microcode read only memories (ROMs), etc. In one example, the core 1390 includes a microcode ROM (not shown) or other medium that stores microcode for certain macroinstructions (e.g., in decode circuitry 1340 or otherwise within the front-end circuitry 1330). In one example, the decode circuitry 1340 includes a micro-operation (micro-op) or operation cache (not shown) to hold/cache decoded operations, micro-tags, or micro-operations generated during the decode or other stages of the processor pipeline 1300. The decode circuitry 1340 may be coupled to rename/allocator unit circuitry 1352 in the execution engine circuitry 1350.

The execution engine circuitry 1350 includes the rename/allocator unit circuitry 1352 coupled to retirement unit circuitry 1354 and a set of one or more scheduler(s) circuitry 1356. The scheduler(s) circuitry 1356 represents any number of different schedulers, including reservations stations, central instruction window, etc. In some examples, the scheduler(s) circuitry 1356 can include arithmetic logic unit (ALU) scheduler/scheduling circuitry, ALU queues, address generation unit (AGU) scheduler/scheduling circuitry, AGU queues, etc. The scheduler(s) circuitry 1356 is coupled to the physical register file(s) circuitry 1358. Each of the physical register file(s) circuitry 1358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1358 includes vector registers unit circuitry, writemask registers unit circuitry, and scalar register unit circuitry. These register units may provide architectural vector registers, vector mask registers, general-purpose registers, etc. The physical register file(s) circuitry 1358 is coupled to the retirement unit circuitry 1354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1354 and the physical register file(s) circuitry 1358 are coupled to the execution cluster(s) 1360. The execution cluster(s) 1360 includes a set of one or more execution unit(s) circuitry 1362 and a set of one or more memory access circuitry 1364. The execution unit(s) circuitry 1362 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1356, physical register file(s) circuitry 1358, and execution cluster(s) 1360 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1364). It should also be understood that where separate pipelines are used, one or more of these pipelines may be out-of-order issue/execution and the rest in-order.

In some examples, the execution engine unit circuitry 1350 may perform load store unit (LSU) address/data pipelining to an Advanced Microcontroller Bus (AMB) interface (not shown), and address phase and writeback, data phase load, store, and branches.

The set of memory access circuitry 1364 is coupled to the memory unit circuitry 1370, which includes data TLB circuitry 1372 coupled to data cache circuitry 1374 coupled to level 2 (L2) cache circuitry 1376. In one example, the memory access circuitry 1364 may include load unit circuitry, store address unit circuitry, and store data unit circuitry, each of which is coupled to the data TLB circuitry 1372 in the memory unit circuitry 1370. The instruction cache circuitry 1334 is further coupled to the level 2 (L2) cache circuitry 1376 in the memory unit circuitry 1370. In one example, the instruction cache 1334 and the data cache 1374 are combined into a single instruction and data cache (not shown) in L2 cache circuitry 1376, level 3 (L3) cache circuitry (not shown), and/or main memory. The L2 cache circuitry 1376 is coupled to one or more other levels of cache and eventually to a main memory.

The core 1390 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1390 includes logic to support a packed data instruction set architecture extension (e.g., AVX1, AVX2), thereby allowing the operations used by many multimedia applications to be performed using packed data.

### Example Execution Unit(s) Circuitry

FIG. 14 illustrates examples of execution unit(s) circuitry, such as execution unit(s) circuitry 1362 of FIG. 13(B). As illustrated, execution unit(s) circuitry 1362 may include one or more ALU circuits 1401, optional vector/single instruction multiple data (SIMD) circuits 1403, load/store circuits 1405, branch/jump circuits 1407, and/or Floating-point unit (FPU) circuits 1409. ALU circuits 1401 perform integer arithmetic and/or Boolean operations. Vector/SIMD circuits 1403 perform vector/SIMD operations on packed data (such as SIMD/vector registers). Load/store circuits 1405 execute load and store instructions to load data from memory into registers or store from registers to memory. Load/store circuits 1405 may also generate addresses. Branch/jump circuits 1407 cause a branch or jump to a memory address depending on the instruction. FPU circuits 1409 perform floating-point arithmetic. The width of the execution unit(s) circuitry 1362 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products. Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

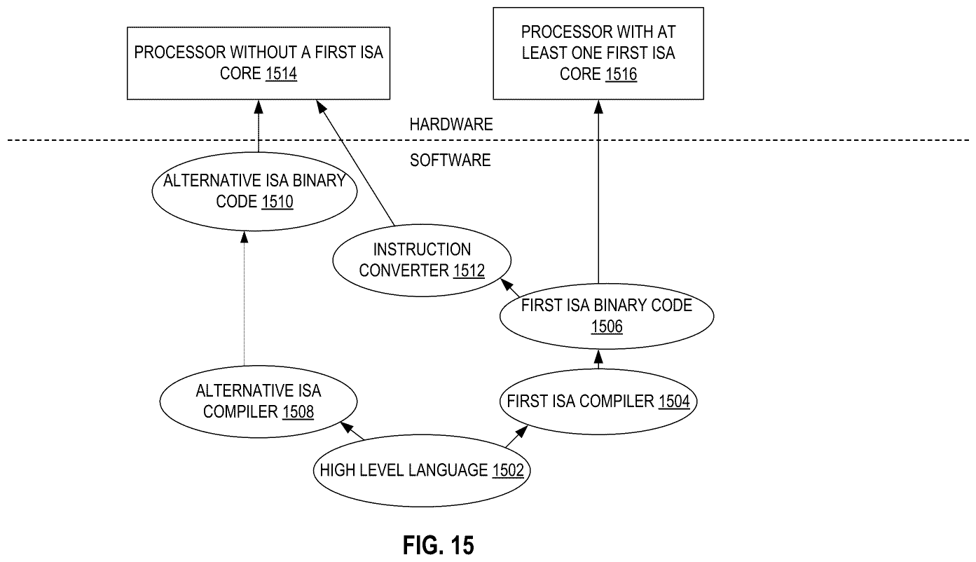

FIG. 15 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 15 shows a program in a high-level language 1502 may be compiled using a first ISA compiler 1504 to generate first ISA binary code 1506 that may be natively executed by a processor with at least one first ISA core 1516. The processor with at least one first ISA core 1516 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1504 represents a compiler that is operable to generate first ISA binary code 1506 (e.g., object code) that can, with or without additional linkage processing, be executed on the processor with at least one first ISA core 1516. Similarly, FIG. 15 shows the program in the high-level language 1502 may be compiled using an alternative ISA compiler 1508 to generate alternative ISA binary code 1510 that may be natively executed by a processor without a first ISA core 1514. The instruction converter 1512 is used to convert the first ISA binary code 1506 into code that may be natively executed by the processor without a first ISA core 1514. This converted code is not necessarily to be the same as the alternative ISA binary code 1510; however, the converted code will accomplish the general operation and be made up of instructions from the alternative ISA. Thus, the instruction converter 1512 represents software, firmware, hardware, or a combination thereof that, through emulation, simulation, or any other process, allows a processor or other electronic device that does not have a first ISA processor or core to execute the first ISA binary code 1506.

References to “one example,” “an example,” “one embodiment,” “an embodiment,” etc., indicate that the example or embodiment described may include a particular feature, structure, or characteristic, but every example or embodiment may not necessarily include the particular feature, structure, or characteristic. Moreover, such phrases do not necessarily refer to the same example or embodiment. Further, when a particular feature, structure, or characteristic is described in connection with an example or embodiment, it is submitted that it is within the knowledge of one skilled in the art to affect such feature, structure, or characteristic in connection with other examples or embodiments whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e., A and B, A and C, B and C, and A, B and C). As used in this specification and the claims and unless otherwise specified, the use of the ordinal adjectives “first,” “second,” “third,” etc. to describe an element merely indicates that a particular instance of an element or different instances of like elements are being referred to and is not intended to imply that the elements so described must be in a particular sequence, either temporally, spatially, in ranking, or in any other manner. Also, as used in descriptions of embodiments, a “/” character between terms may mean that what is described may include or be implemented using, with, and/or according to the first term and/or the second term (and/or any other additional terms).

Also, the terms “bit,” “flag,” “field,” “entry,” “indicator,” etc., may be used to describe any type or content of a storage location in a register, table, database, or other data structure, whether implemented in hardware or software, but are not meant to limit embodiments to any particular type of storage location or number of bits or other elements within any particular storage location. For example, the term “bit” may be used to refer to a bit position within a register and/or data stored or to be stored in that bit position. The term “clear” may be used to indicate storing or otherwise causing the logical value of zero to be stored in a storage location, and the term “set” may be used to indicate storing or otherwise causing the logical value of one, all ones, or some other specified value to be stored in a storage location; however, these terms are not meant to limit embodiments to any particular logical convention, as any logical convention may be used within embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A processor device comprising:
an instruction decoder to decode one or more instructions to copy a memory region; and
execution circuitry coupled to the instruction decoder, the execution circuitry to perform operations corresponding to the one or more instructions, including:
detecting an integrity check value (ICV) mismatch;
determining whether a granule in the memory region represents a tripwire;
determining a suppression mode associated with the one or more instructions; and
in response to determining that the suppression mode allows copying the tripwire, copying the tripwire.

2. The processor device of claim 1, wherein the operations also include, in response to determining that the suppression mode disallows copying the tripwire, invoking an ICV mismatch handler.

3. The processor device of claim 2, wherein the operations also include, in response to determining that the suppression mode allows copying the tripwire, suppressing the ICV mismatch handler.

4. The processor device of claim 1, wherein the tripwire is between two different fields of a data structure.

5. The processor device of claim 1, wherein the operations also include:
comparing a first field depth value and a second field depth value, the first field depth value indicated in the tripwire, the second field depth value indicated in an address associated with the tripwire; and
in response to detecting a mismatch between the first field depth value and the second field depth value, generating an exception without copying the tripwire.

6. The processor device of claim 5, wherein the tripwire is between two different levels of a nested data structure.

7. The processor device of claim 1, wherein the granule consists of data and an associated ICV based on a tweak involving a linear address.

8. A method comprising:
decoding, with an instruction decoder of a processor device, one or more instructions to copy a memory region; and
performing, by the processor device, one or more operations corresponding to the one or more instructions, including:
detecting an integrity check value (ICV) mismatch;
determining whether a granule in the memory region represents a tripwire;
determining a suppression mode associated with the one or more instructions; and
in response to determining that the suppression mode allows copying the tripwire, copying the tripwire.

9. The method of claim 8, wherein the operations also include, in response to determining that the suppression mode disallows copying the tripwire, invoking an ICV mismatch handler.

10. The method of claim 9, wherein the operations also include, in response to determining that the suppression mode allows copying the tripwire, suppressing the ICV mismatch handler.

11. The method of claim 8, wherein the tripwire is between two different fields of a data structure.

12. The method of claim 8, wherein the operations also include:
comparing a first field depth value and a second field depth value, the first field depth value indicated in the tripwire, the second field depth value indicated in an address associated with the tripwire; and
in response to detecting a mismatch between the first field depth value and the second field depth value, generating an exception without copying the tripwire.

13. The method of claim 12, wherein the tripwire is between two different levels of a nested data structure.

14. The method of claim 8, wherein the granule consists of data and an associated ICV based on a tweak involving a linear address.

15. A non-transitory machine-readable medium storing instructions which, when executed by a machine, causes the machine to perform a method comprising:
detecting an integrity check value (ICV) mismatch;
determining whether a granule in the memory region represents a tripwire;
determining a suppression mode associated with one or more of the instructions; and
in response to determining that the suppression mode allows copying the tripwire, copying the tripwire.

16. The non-transitory machine-readable medium of claim 15, wherein the method also includes:
in response to determining that the suppression mode disallows copying the tripwire, invoking an ICV mismatch handler; and
in response to determining that the suppression mode allows copying the tripwire, suppressing the ICV mismatch handler.

17. The non-transitory machine-readable medium of claim 15, wherein the tripwire is between two different fields of a data structure.

18. The non-transitory machine-readable medium of claim 15, wherein the method also includes:
comparing a first field depth value and a second field depth value, the first field depth value indicated in the tripwire, the second field depth value indicated in an address associated with the tripwire; and
in response to detecting a mismatch between the first field depth value and the second field depth value, generating an exception without copying the tripwire.

19. The non-transitory machine-readable medium of claim 18, wherein the tripwire is between two different levels of a nested data structure.

20. The non-transitory machine-readable medium of claim 15, wherein the granule consists of data and an associated ICV based on a tweak involving a linear address.
